(19) United States
(12) Patent Application Publication
(10) Pub. No.: US 2022/0315742 A1
(43) Pub. Date: Oct. 6, 2022

(54) THERMALLY EXPANDABLE FIRE-RESISTANT RESIN COMPOSITION AND THERMALLY EXPANDABLE FIRE-RESISTANT SHEET

(71) Applicant: Panasonic Intellectual Property Management Co., Ltd., Osaka (JP)

(72) Inventors: Kenji SAKAMOTO, Osaka (JP); Satoru MORIYA, Osaka (JP); Kouiti WATANABE, Osaka (JP)

(21) Appl. No.: 17/629,383

(22) PCT Filed: Jul. 9, 2020
(86) PCT No.: PCT/JP2020/026917

§ 371 Date: Jan. 23, 2022

(30) Foreign Application Priority Data
Sep. 12, 2019 (JP) 2019-166677

(51) Int. Cl. C08L 23/06; B32B 27/12; B32B 27/20; B32B 27/28

(52) U.S. Cl. CPC C08L 23/06; B32B 27/12; B32B 27/20; B32B 27/28; B32B 2264/1022; B32B 2307/3065; B32B 2262/101

(57) ABSTRACT

A thermally expandable fire-resistant resin composition contains a vinyl resin, a nitrogen-containing foaming agent, a phosphorus flame retardant, a polyhydric alcohol, titanium dioxide, and a straight-chain acrylic polymer. The straight-chain acrylic polymer has a weight-average molecular weight within a range of greater than or equal to 4,000,000 and less than or equal to 20,000,000.

### TECHNICAL FIELD

The present disclosure generally relates to thermally expandable fire-resistant resin compositions and thermally expandable fire-resistant sheets and more specifically, to a thermally expandable fire-resistant resin composition and a thermally expandable fire-resistant sheet containing a foaming agent.

### BACKGROUND ART

Patent Literature 1 discloses a covering material. The covering material includes a binder, a flame retardant, a foaming agent, a carbonizing agent, and a filler. The covering material further includes, as the binder, a vinyl acetate-ethylene copolymer resin having a melt mass-flow rate of 0.1 to 300 g/10 min at 190° C. and a vinyl acetate content of 15 to 50 mass %. The covering material is used to protect various kinds of base materials (building frames) in buildings and the like from a high temperature.

The covering material of Patent Literature 1 foams when subjected to a high temperature such as a fire, thereby forming a carbonized thermal insulation layer. The covering material of the Patent Literature 1 foams but may difficultly retain the shape of the carbonized thermal insulation layer and may easily collapse. This may result in unsatisfactory fire resistance.

### CITATION LIST

### Patent Literature

Patent Literature 1: WO 2013/008819

### SUMMARY OF INVENTION

It is an object of the present disclosure to provide a thermally expandable fire-resistant resin composition and a thermally expandable fire-resistant sheet with improved fire-resistant foaming properties and improved foam denseness.

The thermally expandable fire-resistant resin composition according to one aspect of the present disclosure contains a vinyl resin, a nitrogen-containing foaming agent, a phosphorus flame retardant, a polyhydric alcohol, titanium dioxide, and a straight-chain acrylic polymer. The straight-chain acrylic polymer has a weight-average molecular weight within a range of greater than or equal to 4,000,000 and less than or equal to 20,000,000.

A thermally expandable fire-resistant sheet according to one aspect of the present disclosure includes a resin layer formed from the thermally expandable fire-resistant resin composition.

### BRIEF DESCRIPTION OF DRAWINGS

FIG. 1A is a schematic sectional view of a thermally expandable fire-resistant sheet according to an embodiment of the present disclosure before heating, and FIG. 1B is a schematic sectional view of the thermally expandable fire-resistant sheet after the heating;

FIG. 2 is a schematic sectional view of a conventional thermally expandable fire-resistant sheet after heating; and

FIG. 3A is a sectional photograph of a thermally expandable fire-resistant sheet of Example 1 after heating, and FIG. 3B is a sectional photograph of a thermally expandable fire-resistant sheet of Comparative Example 1 after heating.

### DESCRIPTION OF EMBODIMENTS

### (1) Overview

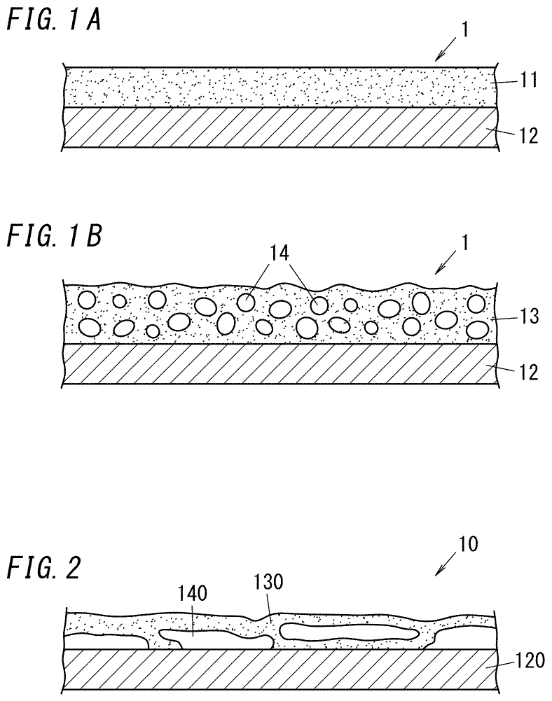

In FIG. 1A, a thermally expandable fire-resistant sheet 1 according to the present embodiment is shown. The thermally expandable fire-resistant sheet 1 includes a resin layer 11. The resin layer 11 is formed from a thermally expandable fire-resistant resin composition. The thermally expandable fire-resistant resin composition contains a vinyl resin, a nitrogen-containing foaming agent, a phosphorus flame retardant, a polyhydric alcohol, titanium dioxide, and a straight-chain acrylic polymer. The fire-resistant mechanism of the thermally expandable fire-resistant sheet 1 will be described below.

When the thermally expandable fire-resistant sheet 1 is subjected to heat such as fire heat, the resin layer 11 starts foaming, thereby forming a foamable heat-insulating layer 13 as shown in FIG. 1B. The foamable heat-insulating layer 13 includes a large number of fine air bubbles 14. This enables the thermally expandable fire-resistant sheet 1 to exhibit fire resistance performance. The temperature of fire heat is, for example, higher than or equal to 600° C.

In FIG. 2, a conventional thermally expandable fire-resistant sheet 10 is shown. When subjected to heat such as fire heat, the conventional thermally expandable fire-resistant sheet 10 also forms a foamable heat-insulating layer 130. However, air bubbles 140 in the foamable heat-insulating layer 130 formed in this case tend to be large. In addition, the air bubbles 140 may become excessively large and may thus disappear (so-called defoaming or bursting of bubbles). This makes it difficult for the foamable heat-insulating layer 130 to retain its shape, and thus, the foamable heat-insulating layer 130 is more likely to collapse. Thus, it becomes difficult for the conventional thermally expandable fire-resistant sheet 10 to express satisfactory fire resistance performance.

Here, each of large air bubbles 140 shown in FIG. 2 may be a single air bubble which has gradually enlarged or may be a bubble into which a plurality of air bubbles having various sizes have coalesced. One of the causes may be that a resin present around each air bubble is extremely stretchy and easy to break.

Thus, in the present embodiment, the weight-average molecular weight of the straight-chain acrylic polymer is set within the range of greater than or equal to 4,000,000 and less than or equal to 20,000,000, thereby suppressing the large air bubbles 140 as shown in FIG. 2 from being formed. In addition, air bubbles once formed are also suppressed from disappearing.

Thus, the present embodiment enables fire-resistant foaming properties and foam denseness to be improved. Note that the fire-resistant foaming properties are evaluated based on, for example, the expansion ratio of the resin layer 11. The foam denseness is evaluated based on the average diameter, diameter distribution, density, and the like of air bubbles in the foamable heat-insulating layer 13. Specific test methods of the fire-resistant foaming properties and the foam denseness will be described in the item “Examples”.

### (2) Details

<Thermally Expandable Fire-resistant Resin Composition>

The thermally expandable fire-resistant resin composition according to the present embodiment contains a vinyl resin, a nitrogen-containing foaming agent, a phosphorus flame retardant, a polyhydric alcohol, titanium dioxide, and a straight-chain acrylic polymer. In the present specification, a remaining portion of the thermally expandable fire-resistant resin composition that excludes the straight-chain acrylic polymer may be referred to as a “base material”. Each component contained in the thermally expandable fire-resistant resin composition will be described below.

<<Vinyl Resin>>

The vinyl resin is a polyvinyl compound. The polyvinyl compound is a resin obtained by polymerization of monomers having vinyl groups. The vinyl resin is not particularly limited but preferably includes an EVA resin and/or a polyolefin resin.

[EVA Resin]

The EVA resin is an ethylene-vinyl acetate copolymer. The EVA resin is produced by a high-pressure polymerization method. The EVA resin is a resin having rubber elasticity and excellent low temperature characteristics and weatherability. The content percentage of the vinyl acetate in the EVA resin is not particularly limited but is, for example, within the range of higher than or equal to 5% and lower than or equal to 30%. Changing the content percentage of the vinyl acetate enables flexibility, adhesiveness, heat-sealing properties, and the like to be controlled in a wide range. Note that the content percentage of the vinyl acetate is measurable by a method compliant with JISK6924-1.

The EVA resin can make the resin layer 11 be an excellent foamable heat-insulating layer 13 when the resin layer 11 of the thermally expandable fire-resistant sheet 1 is heated. Furthermore, when the thermally expandable fire-resistant sheet 1 is fixed to an architectural structure portion such as an underlying member, the EVA resin can impart conformability to the thermally expandable fire-resistant sheet 1.

As described above, the EVA resin is a resin having rubber elasticity and excellent low temperature characteristics and weatherability. Thus, the EVA resin can impart these properties to the resin layer 11 of the thermally expandable fire-resistant sheet 1.

Examples of a specific product of the EVA resin include Ultrasen (Nipoflex) (registered trademark) manufactured by TOSOH CORPORATION.

The melt mass-flow rate (MFR) of the EVA resin is preferably within the range of greater than or equal to 0.4 g/10 min and less than or equal to 75 g/10 min. When the melt mass-flow rate is greater than or equal to 0.4 g/10 min, it is possible to satisfactorily maintain the conformability when the thermally expandable fire-resistant sheet 1 is disposed in the architectural structure portion such as the underlying member. Moreover, at the time of freezing and thawing, the resin layer 11 of the thermally expandable fire-resistant sheet 1 does not easily become brittle, and thus it is possible to satisfactorily secure long-term durability against the freezing and thawing. When the melt mass-flow rate is less than or equal to 75 g/10 min, it is possible to satisfactorily maintain the shape retainability of the foamable heat-insulating layer 13 formed by exposure to fire flame or the like. Note that the melt mass-flow rate is measurable by a method compliant with JIS K6924-1.

The content of the EVA resin is preferably within the range of greater than or equal to 15 parts by mass and less than or equal to 40 parts by mass based on 100 parts by mass of the base material. When the content of the EVA resin is greater than or equal to 15 parts by mass, it is possible to improve the toughness of the thermally expandable fire-resistant sheet 1 when the resin layer 11 is formed from the thermally expandable fire-resistant resin composition. When the content of the EVA resin is less than or equal to 40 parts by mass, it is possible to maintain the shape of the foamable heat-insulating layer 13 when the thermally expandable fire-resistant sheet 1 is exposed to fire heat. The content of the EVA resin is more preferably within the range of greater than 18 parts by mass and less than 35 parts by mass, much more preferably within the range of greater than 18 parts by mass and less than 28 parts by mass based on 100 parts by mass of the base material.

[Polyolefin Resin]

The polyolefin resin is a polymer of olefin. The polyolefin resin is not particularly limited, and examples of the polyolefin resin include polyethylene, polypropylene, polyisobutylene, polyisoprene, and polybutadiene. Preferably, the polyolefin resin contains a metallocene plastomer.

The metallocene plastomer can make the resin layer 11 be an excellent foamable heat-insulating layer 13 when the resin layer 11 of the thermally expandable fire-resistant sheet 1 is heated. Moreover, the metallocene plastomer can impart the gas barrier property to the thermally expandable fire-resistant sheet 1. Furthermore, when the thermally expandable fire-resistant sheet 1 is fixed to an architectural structure portion such as an underlying member, the metallocene plastomer can impart conformability to the thermally expandable fire-resistant sheet 1. Note that “plastomer” means a polymer having the property of easily flowable and deformable into a shape by heat and solidifiable in the shape. The plastomer is a term opposite in meaning to an elastomer (which has such a property that when external force is applied to the elastomer, the elastomer deforms according to the external force, and when the external force is removed, the elastomer returns to its original shape in a short time), and the plastomer does not exhibit elastic deformation unlike the elastomer but easily deforms plastically. In the present embodiment, the metallocene plastomer is a polymer obtained through polymerization of ethylene and olefin, such as α-olefin, in the presence of a catalyst, namely, metallocene as the catalyst.

The metallocene plastomer has high flexibility and high heat resistance, as well as excellent impact resistance. Thus, the metallocene plastomer can impart impact resistance and flexibility to the resin layer 11 of the thermally expandable fire-resistant sheet 1.

A method of producing the metallocene plastomer is not particularly limited, but as described above, the metallocene plastomer is obtained by accordingly polymerizing ethylene and olefin such as α-olefin in the presence of a metallocene catalyst. Examples of specific products of the metallocene plastomer include C6 EXCELLEN FX (FX201, FX301, FX307, and FX402) and C4 EXCELLEN FX (FX352, FX555, FX551, and FX558) of EXCELLEN (registered trademark) FX series manufactured by Sumitomo Chemical Company, Limited, and Kernel (KF260T) manufactured by Japan polyethylene Corporation. Of course, the metallocene plastomer is not limited to the specific examples mentioned above but is at least a copolymer obtained by polymerizing olefin in the presence of the metallocene catalyst as described above.

The melt mass-flow rate of the metallocene plastomer is preferably within a range of greater than or equal to 2 g/10 min and less than or equal to 40 g/10 min. When the melt mass-flow rate is greater than or equal to 2 g/10 min, it is possible to satisfactorily maintain the conformability when the thermally expandable fire-resistant sheet 1 is disposed in the architectural structure portion such as the underlying member. Moreover, at the time of freezing and thawing, the resin layer 11 of the thermally expandable fire-resistant sheet 1 does not easily become brittle, and thus it is possible to satisfactorily secure long-term durability against the freezing and thawing. When the melt mass-flow rate is less than or equal to 40 g/10 min, it is possible to satisfactorily maintain the shape retainability of the foamable heat-insulating layer formed by exposure to fire flame or the like. Moreover, in this case, it is possible to make the gas barrier property of the thermally expandable fire-resistant sheet 1 less likely to decrease, and to satisfactorily secure the long-term durability under a high-temperature and humidity atmosphere. The melt mass-flow rate is more preferably within the range of greater than or equal to 4 g/10 min and less than or equal to 30 g/10 min.

The content of the metallocene plastomer is preferably within the range of greater than or equal to 15 parts by mass and less than or equal to 40 parts by mass based on 100 parts by mass of the base material. When the content of the metallocene plastomer is greater than or equal to 15 parts by mass, it is possible to improve the toughness of the thermally expandable fire-resistant sheet 1 when the resin layer 11 is formed from the thermally expandable fire-resistant resin composition. Moreover, in this case, it is possible to secure a satisfactory gas-barrier property of the thermally expandable fire-resistant sheet 1 and satisfactorily maintain the long-term durability under the hot and humid condition. When the content of the metallocene plastomer is less than or equal to 40 parts by mass, it is possible to maintain the shape of the foamable heat-insulating layer 13 when the thermally expandable fire-resistant sheet 1 is exposed to fire heat. The content of the metallocene plastomer is more preferably within the range of greater than 18 parts by mass and less than 35 parts by mass, much more preferably within the range greater than 18 parts by mass and less than 28 parts by mass based on 100 parts by mass of the base material.

<<Nitrogen-Containing Foaming Agent>>

The nitrogen-containing foaming agent is a foaming agent containing nitrogen atoms. The nitrogen-containing foaming agent decomposes when exposed to fire heat and generates a non-combustible gas such as nitrogen and/or ammonia. The nitrogen-containing foaming agent further has a role of expanding and foaming the vinyl resin carbonizing due to fire heat and the polyhydric alcohol to form the foamable heat-insulating layer 13. Moreover, the nitrogen-containing foaming agent can impart toughness to the thermally expandable fire-resistant sheet 1. This enables the thermally expandable fire-resistant sheet 1 to exhibit satisfactory conformability to the architectural structure portion.

The nitrogen-containing foaming agent is not particularly limited, but examples of the nitrogen-containing foaming agent include melamine, a melamine derivative, dicyandiamide, azodicarbonamide, urea, and guanidine. That is, the nitrogen-containing foaming agent contains at least one selected from the group consisting of the above-mentioned examples. In light of the generation efficiency of the noncombustible gas, the conformability to the architectural structure portion, and the fire resistance, the nitrogen-containing foaming agent preferably contains at least one of melamine or dicyandiamide and more preferably contains at least melamine.

The content of the nitrogen-containing foaming agent is preferably within the range of greater than or equal to 5 parts by mass and less than or equal to 25 parts by mass based on 100 parts by mass of the base material. When the content of the nitrogen-containing foaming agent is greater than or equal to 5 parts by mass, it is possible to satisfactorily form a foamable heat-insulating layer 13 at the time of exposure to fire heat. In addition, it is possible to secure the toughness of the thermally expandable fire-resistant sheet 1. When the content of the nitrogen-containing foaming agent is less than or equal to 25 parts by mass, it is possible to secure the shape retainability of the foamable heat-insulating layer 13 formed by fire heat. In addition, even if freezing and thawing are repeated, the thermally expandable fire-resistant sheet 1 is less likely to harden, and it is possible to suppress degradation of the fire resistance. The content of the nitrogen-containing foaming agent is more preferably greater than or equal to 8 parts by mass and less than or equal to 23 parts by mass based on 100 parts by mass of the base material.

<<Phosphorus Flame Retardant>>

The phosphorus flame retardant is a flame retardant containing at least one of phosphorus alone or a phosphorus compound. The phosphorus flame retardant has the effect of dehydrating the polyhydric alcohol when exposed to fire heat to form a thin film called “char” on a surface of the foamable heat-insulating layer 13. Moreover, the phosphorus flame retardant reacts with the titanium dioxide to produce a titanium pyrophosphate when heated at a high temperature higher than or equal to 600° C. The titanium pyrophosphate remains as an ashed component in the foamable heat-insulating layer 13, thereby improving the shape retainability of the foamable heat-insulating layer 13.

The phosphorus flame retardant is not particularly limited, and examples thereof includes red phosphorus, a phosphate ester, a phosphate metal salt, a phosphate ammonium, phosphate melamine, a phosphate amide, and ammonium polyphosphates. Examples of the phosphate ester include triphenylphosphate and tricresyl phosphate. Examples of the metal phosphate salt include sodium phosphate and magnesium phosphate. Examples of the ammonium polyphosphates include a polyphosphate ammonium and a melamine modified ammonium polyphosphate. Of these substances, the ammonium polyphosphates are preferably contained in the phosphorus flame retardant, in particular, in view of the satisfactory formation of the foamable heat-insulating layer 13, the shape retainability and long-term durability of the foamable heat-insulating layer 13. The phosphorus flame retardant may be only one kind or two or more kinds of the group consisting of the above-mentioned examples. When the ammonium polyphosphates are exposed to fire heat, and the temperature of the ammonium polyphosphates reaches a decomposition temperature, the ammonium polyphosphates desorb ammonia to produce a phosphoric acid and a condensed phosphoric acid. The phosphoric acid and the condensed phosphoric acid dehydrate and carbonize the polyhydric alcohol, thereby forming char. Moreover, an ammonia gas generated by decomposition of the ammonium polyphosphates, an ammonia gas and a nitrogen gas generated by decomposition of the nitrogen-containing foaming agent, and the like cause the entirety of the resin layer 11 to expand and foam. The generation of non-combustible gases such as the ammonia gas and the nitrogen gas reduces the concentration of oxygen, and thus, burning is further suppressible. Moreover, the ammonium polyphosphates also decompose when heated at a high temperatures higher than or equal to 600° C., and the ammonium polyphosphates react with the titanium dioxide, thereby producing the titanium pyrophosphate. The titanium pyrophosphate remains as an ashed component in the foamable heat-insulating layer 13, thereby improving the shape retainability of the foamable heat-insulating layer 13.

The content of the phosphorus flame retardant is preferably within the range of greater than or equal to 20 parts by mass and less than or equal to 50 parts by mass based on 100 parts by mass of the base material. When the content of the phosphorus flame retardant is greater than or equal to 20 parts by mass, it is possible to effectively carbonize and foam the resin layer 11 of the thermally expandable fire-resistant sheet 1. Further, it is possible to secure the shape retainability of the foamable heat-insulating layer 13 thus formed. When the content of the phosphorus flame retardant is less than or equal to 50 parts by mass, it is possible to secure fire resistance in the case of an environment being hot and humid. The content of the phosphorus flame retardant is more preferably greater than or equal to 30 parts by mass and less than or equal to 50 parts by mass based on 100 parts by mass of the base material.

<<Polyhydric Alcohol>>

The polyhydric alcohol is dehydrated and carbonized by the phosphorus flame retardant when exposed to fire heat and contributes to the formation of the foamable heat-insulating layer 13 from the resin layer 11. The decomposition temperature of the polyhydric alcohol is preferably higher than or equal to 180° C., more preferably higher than or equal to 220° C. Examples of the polyhydric alcohol include monopentaerythritol, dipentaerythritol and tripentaerythritol, poly saccharide such as starch and cellulose, and an oligosaccharide such as glucose and fructose. The polyhydric alcohol may be one of, or a combination of two or more of, the above-mentioned components. In particular, the polyhydric alcohol preferably contains at least one selected from the group consisting of monopentaerythritol, dipentaerythritol, and tripentaerythritol. In this case, the foamability of the resin layer 11 of the thermally expandable fire-resistant sheet 1 can be particularly improved.

The content of the polyhydric alcohol is preferably within the range of greater than or equal to 5 parts by mass and less than or equal to 25 parts by mass based on 100 parts by mass of the base material. When the content of the polyhydric alcohol is greater than or equal to 5 parts by mass, it is possible to satisfactorily form the foamable heat-insulating layer 13 from the resin layer 11. It is also possible to secure the shape retainability of the foamable heat-insulating layer 13. When the content of the polyhydric alcohol is less than or equal to 25 parts by mass, it is possible to maintain the gas barrier property of the resin layer 11 of the thermally expandable fire-resistant sheet 1 even under the hot and humid condition, and to maintain satisfactory fire resistance. It is also possible to secure the conformability of the thermally expandable fire-resistant sheet 1 to the architectural structure portion.

Here, the mass ratio of the nitrogen-containing foaming agent to the polyhydric alcohol is preferably within the range of greater than or equal to 0.2 and less than 4.0. Thus, it is possible to secure the gas barrier property under the hot and humid condition and under a freezing and thawing condition, and in case of fire, it is possible to secure the fire resistance and the conformability to the architectural structure portion. That is, in this case, the thermally expandable fire-resistant sheet 1 can form a foamable heat-insulating layer 13 excellent in shape retainability while securing the fire resistance and the conformability. Therefore, the foamable heat-insulating layer 13 formed from the resin layer 11 by fire flame is hardly detached from the architectural structure portion and thus, it is possible to suppress fire from spreading to a building and collapsing of the building due to the flame. Note that freezing melting condition means a condition in which freezing and thawing are repeated.

<<Titanium Dioxide>>

When the titanium dioxide is heated at a high temperature higher than or equal to 600° C., the titanium dioxide reacts with the phosphorus flame retardant, thereby producing titanium pyrophosphate. The titanium pyrophosphate remains as an ashed component in the foamable heat-insulating layer 13, thereby improving the shape retainability of the foamable heat-insulating layer 13.

The crystalline structure of the titanium dioxide may be anatase-type or rutile-type but is not limited these examples. An average particle diameter of the titanium dioxide is preferably within a range of greater than or equal to 0.01 μm and less than or equal to 200 μm, more preferably within a range of greater than or equal to 0.1 μm and less than or equal to 100 μm. Note that the average particle diameter refers to a particle diameter at a point corresponding to 50% in a cumulative volume distribution curve of a particle size distribution obtained on a volumetric basis, where a total volume is 100%, that is, refers to a diameter (D50) corresponding to 50% in the volume-based cumulative. The average particle diameter is obtained by measuring with, for example, a laser diffraction particle size distribution measurement device.

The content of the titanium dioxide is preferably within the range of greater than or equal to 5 parts by mass and less than or equal to 30 parts by mass based on 100 parts by mass of the base material. When the content of the titanium dioxide is greater than or equal to 5 parts by mass, it is possible to produce sufficient titanium pyrophosphates by heat at a high temperature higher than or equal to 600° C. Thus, the titanium pyrophosphates as ashed components sufficiently remain in the foamable heat-insulating layer 13, thereby further improving the shape retainability of the foamable heat-insulating layer 13. When the content of the titanium dioxide is less than or equal to 30 parts by mass, it is possible to suppress a decrease in the foaming ratio and further improve the fire resistance and the conformability to the architectural structure portion at the time of freezing and thawing. Note that the expansion ratio is obtained, for example, as a ratio of the apparent density of the foamable heat-insulating layer 13 after foaming to the density of the resin layer 11 before foaming (solid). Moreover, the expansion ratio may be obtained as a ratio of the thickness of the foamable heat-insulating layer 13 after foaming to the thickness of the resin layer 11 before foaming.

<<Straight-Chain Acrylic Polymer>>

The straight-chain acrylic polymer includes a polymer of acrylic acid ester (polyacrylate), a polymer of ester methacrylate (polymethacrylate), and a copolymer of acrylic acid ester and ester methacrylate.

The weight-average molecular weight of the straight-chain acrylic polymer is within the range of greater than or equal to 4,000,000 and less than or equal to 20,000,000. As described above, when a high-molecular-weight straight-chain acrylic polymer is contained in the thermally expandable fire-resistant resin composition, melt elasticity can be improved. That is, the long chain of molecules in the straight-chain acrylic polymer becomes entangled in molecules of a matrix resin (typically, a vinyl resin), thereby achieving a pseudo-crosslinked state, which imparts melt elasticity to the thermally expandable fire-resistant resin composition. The melt elasticity also improves the appearance of a product. The longer a molecular chain of the straight-chain acrylic polymer is, that is, the greater the weight-average molecular weight is, the higher the melt elasticity imparting effect of the straight-chain acrylic polymer. Examples of a specific product of the straight-chain acrylic polymer include METABLEN (registered trademark) Type P manufactured by Mitsubishi Chemical Corporation.

When, however, the weight-average molecular weight of a straight-chain acrylic polymer is less than 4,000,000, the molecular chain of the straight-chain acrylic polymer having such a low molecular weight hardly becomes entangled in the molecules of the matrix resin, and thus, the pseudo-crosslinked state is not easily achieved. Then, similarly to the case of the conventional thermally expandable fire-resistant sheet 10 shown in FIG. 2, the air bubbles 140 in the foamable heat-insulating layer 130 enlarge or excessively enlarge when subjected to heat such as fire heat, resulting in the disappearance of the air bubbles 140. In contrast, when the weight-average molecular weight of a straight-chain acrylic polymer is greater than 20,000,000, the straight-chain acrylic polymer having such an ultrahigh molecular weight may reduce the fluidity of the thermally expandable fire-resistant resin composition. Moreover, the components contained in the thermally expandable fire-resistant resin composition may not be uniformly mixed with each other.

The content of the straight-chain acrylic polymer is preferably within the range of greater than or equal to 0.1 parts by mass and less than or equal to 8 parts by mass, more preferably within the range of greater than or equal to 0.1 parts by mass and less than or equal to 7 parts by mass based on 100 parts by mass of a base material. Thus, reducing the upper limit value of the content of the straight-chain acrylic polymer enables the fluidity of the thermally expandable fire-resistant resin composition to be suppressed from being reduced.

<<Others>>

The thermally expandable fire-resistant resin composition may contain any additive such as a plasticizer, a tackifier, an inorganic filler, an antioxidant, a lubricant, and a processing aid if needed within a range that does not impair the effectiveness of the present embodiment.

Examples of the plasticizer include, but are not limited to, hydrocarbons, phthalic acids, phosphate esters, adipate esters, sebacic acid esters, ricinoleic acid esters, polyesters, epoxies, and chlorinated paraffins. In the present embodiment, the thermally expandable fire-resistant resin composition preferably contains no plasticizer. When the thermally expandable fire-resistant resin composition contains no plasticizer, it is possible to further improve the gas barrier property of the thermally expandable fire-resistant sheet 1.

Examples of the adhesives include, but are not limited to, a rosin resin, a rosin derivative, damar, a polyterpene resin, modified terpene, an aliphatic hydrocarbon resin, a cyclopentadiene resin, an aromatic petroleum resin, a phenol resin, an alkylphenol-acetylene resin, a styrene resin, a xylene resin, a coumarone-indene resin, and a vinyl toluene-α methylstyrene copolymer.

Examples of the inorganic filler include, but are not particularly limited to, an inorganic salt, an inorganic oxide, an inorganic fiber, and inorganic fine particles. Examples of the inorganic salt include calcium carbonate, aluminum hydroxide, magnesium hydroxide, kaolin, clay, bentonite, and talc. Examples of the inorganic oxide include glass flakes and wollastonite. Examples of the inorganic fiber include rock wool, glass fiber, carbon fiber, ceramic fiber, alumina fiber, and silica fiber. Examples of the inorganic fine particles include carbon particles and fumed silica particles.

Examples of the antioxidant include, but are not limited to, an antioxidant containing a phenol compound, an antioxidant containing sulfur atoms, and an antioxidant containing a phosphite compound.

Examples of the lubricant include, but are not limited to, mineral or petroleum-based waxes, vegetable or animal waxes, ester waxes, organic acids, organic alcohols, and an amide-based compound. Examples of the mineral or petroleum-based waxes include polyethylene, paraffins and montanic acids. Examples of the vegetable or animal waxes include tall oil, factice oil, beeswax, carnauba wax, and lanolin. Examples of the organic acids include a stearic acid, a palmitic acid, and ricinoleic acid. Examples of the organic alcohols include a stearyl alcohol. Examples of the amide-based compound includes dimethyl bisamide.

Examples of the processing aid include, but are not limited to, chlorinated polyethylene, a methyl methacrylate-ethyl acrylate copolymer, and a high-molecular-weight polymethyl methacrylate.

Note that the additional components such as additives explained above are mere examples and should not be construed as limiting, and appropriate components may be blended in accordance with characteristics required for the thermally expandable fire-resistant resin composition and the thermally expandable fire-resistant sheet 1.

<<Formation Method of Resin Layer>>

The resin layer 11 may be formed by, for example, the following method.

First of all, the vinyl resin, the nitrogen-containing foaming agent, the phosphorus flame retardant, the polyhydric alcohol, the titanium dioxide, and the straight-chain acrylic polymer, which are described above, and optionally, other components are kneaded with a suitable kneading device, are suspended in an organic solvent or plasticizer, or are warmed and melted, thereby preparing a mixture. Examples of the kneading device include, but are not particularly limited to, a heating roller, a pressurizing kneader, an extruder, a Banbury mixer, a kneader mixer, and a two-piece roll. A kneading temperature is a temperature at which the thermally expandable fire-resistant resin composition is appropriately melted, is at least a temperature at which the polyhydric alcohol is not decomposed, and is, for example, within a range of higher than or equal to 80° C. and lower than or equal to 200° C. The mixture prepared by, for example, the kneading is molded into a sheet by a molding method such as hot press molding, extrusion molding, or calendering, thereby forming the resin layer 11. The resin layer 11 thus produced to have a sheet shape is usable as the thermally expandable fire-resistant sheet 1.

<Thermally Expandable Fire-Resistant Sheet>

The thermally expandable fire-resistant sheet 1 according to the present embodiment includes the resin layer 11 formed from the thermally expandable fire-resistant resin composition. That is, the thermally expandable fire-resistant sheet 1 contains the components described above included in the thermally expandable fire-resistant resin composition.

Thus, the thermally expandable fire-resistant sheet 1 is excellent in fire-resistant foaming properties. Specifically, the expansion ratio of the resin layer 11 of the thermally expandable fire-resistant sheet 1 can increase tenfold or more. Since the expansion ratio is high as explained above, the thermally expandable fire-resistant sheet 1 can have satisfactory fire resistance.

Moreover, the thermally expandable fire-resistant sheet 1 is excellent in foam denseness. That is, the average air bubble diameter of the foamable heat-insulating layer 13 after foaming can be small. Specifically, the average air bubble diameter is preferably less than 1000 μm, more preferably less than 100 μm. Note that the average air bubble diameter is obtainable by, for example, processing a sectional image obtained through observation of the foamable heat-insulating layer 13.

In addition, the thermally expandable fire-resistant sheet 1 is made fire-resistant and durable for a long period of time and is excellent in shape retainability and sheet conformability.

The thickness of the resin layer 11 of the thermally expandable fire-resistant sheet 1 is not particularly limited but is preferably within a range of greater than or equal to 0.1 mm and less than or equal to 5 mm in terms of the conformability to the architectural structure portion when the thermally expandable fire-resistant sheet 1 is installed in the architectural structure portion such as, for example, an underlying member. The thickness of the resin layer 11 of the thermally expandable fire-resistant sheet 1 is more preferably within a range of greater than or equal to 0.3 mm and less than or equal to 3 mm.

The thermally expandable fire-resistant sheet 1 may consist of the resin layer 11 molded in a sheet shape or may include the resin layer 11 and layers such as an inorganic layer, an organic layer, and a metal layer stacked on one surface of the resin layer 11. The thickness of each of the inorganic layer, the organic layer, and the metal layer, and the number, type, order, and the like of these layers stacked are not particularly limited and are selected in accordance with place, object, and the like of use. The thickness (total thickness when two or more layers are stacked) of the layers such as the inorganic layer, the organic layer, and the metal layer is, for example, within a range of greater than or equal to 0.2 mm and less than or equal to 1 mm.

The thermally expandable fire-resistant sheet 1 according to the present embodiment includes the resin layer 11 and an inorganic layer 12. The inorganic layer 12 overlaps the resin layer 11. Examples of the inorganic layer 12 include inorganic fiber such as rock wool, glass wool, glass cloth, and ceramic wool. Among them, glass fiber is preferably contained in the inorganic layer 12. When the inorganic layer 12 contains glass fiber, the foamable heat-insulating layer 13 formed by expansion and foaming of the resin layer 11 by a fire can be made less likely to fall off even if a thermally expandable fire-resistant sheet 1 having a relatively large area is fixed to the architectural structure portion such as the underlying member by a tool such as a tacker. The glass fiber is preferably glass paper, and preferably has basis weight (weight per unit area) greater than or equal to 10 g/m² and less than or equal to 100 g/m² and more preferably greater than or equal to 30 g/m² and less than or equal to 60 g/m².

Examples of the organic layer include: ether-based resins such as polyolefin resins (e.g., a polyethylene resin and a polypropylene resin), a polystyrene resin, polyester resins, a polyurethane resin, and polyamide resins; unsaturated ester resins; and copolymer resins such as an ethylene-vinyl acetate copolymer, an ethylene vinyl alcohol copolymer, and a styrene butadiene copolymer. Examples of the form of the organic layer include a film and nonwoven fabric.

Examples of materials for the metal layer include iron, steel, stainless steel, galvanized steel, aluminum zinc alloy plated steel, and aluminum. In particular, an aluminum foil or the like is preferable in terms of handling property.

The thermally expandable fire-resistant sheet 1 shown in FIG. 1A may be produced by, for example, the following method. That is, the resin layer 11 having a film shape and the inorganic layer 12 are stacked and are integrated with each other in an appropriate method, thereby producing the thermally expandable fire-resistant sheet 1. In this case, the thermally expandable fire-resistant sheet 1 has a 2-layer structure constituted by the resin layer 11 and the inorganic layer 12. Note that the thermally expandable fire-resistant sheet 1 may include three or more layers stacked by further stacking an inorganic layer and the like on an opposite surface of the inorganic layer 12 from the resin layer 11. Moreover, the molding method and temperature and pressure during the molding may be similar to the forming method of the resin layer.

### (3) Summary

As can be seen from the embodiments described above, the present disclosure includes the following aspects. Note that reference signs in parentheses are added only to clarify the correspondence relationship to the embodiments in the following description.

The thermally expandable fire-resistant resin composition of a first aspect contains a vinyl resin, a nitrogen-containing foaming agent, a phosphorus flame retardant, a polyhydric alcohol, titanium dioxide, and a straight-chain acrylic polymer. The straight-chain acrylic polymer has a weight-average molecular weight within a range of greater than or equal to 4,000,000 and less than or equal to 20,000,000.

This aspect enables fire-resistant foaming properties and foam denseness to be improved.

In the thermally expandable fire-resistant resin composition of a second aspect referring to the first aspect, the vinyl resin includes at least one of an EVA resin or a polyolefin resin.

This aspect enables fire-resistant foaming properties and foam denseness to be further improved.

In the thermally expandable fire-resistant resin composition of a third aspect referring to the second aspect, the polyolefin resin contains a metallocene plastomer.

This aspect enables fire-resistant foaming properties and foam denseness to be further improved.

In the thermally expandable fire-resistant resin composition of a fourth aspect referring to any one of the first to third aspects, a content of the straight-chain acrylic polymer is preferably within a range of greater than or equal to 0.1 parts by mass and less than or equal to 8 parts by mass based on 100 parts by mass of a remaining portion of the thermally expandable fire-resistant resin composition that excludes the straight-chain acrylic polymer.

This aspect enables fire-resistant foaming properties and foam denseness to be further improved.

A thermally expandable fire-resistant sheet (1) of a fifth aspect includes a resin layer (11) formed from the thermally expandable fire-resistant resin composition of any one of the first to fourth aspects.

This aspect enables fire-resistant foaming properties and foam denseness to be improved.

A thermally expandable fire-resistant sheet of a sixth aspect referring to the fifth aspect further includes an inorganic layer (12) overlapping the resin layer (11). The inorganic layer (12) includes glass fiber.

This aspect enables fire-resistant foaming properties and foam denseness to be further improved.

### EXAMPLES

The present disclosure will be specifically described with reference to examples below. However, the present disclosure is not limited to these examples. Various modifications may be made depending on design as long as the object of the present disclosure is achieved.

(1) Preparation of Thermally Expandable Fire-Resistant Resin Composition

Based on the contents shown in each of Table 1 to Table 3, the vinyl resin, the nitrogen-containing foaming agent, the phosphorus flame retardant, the polyhydric alcohol, the titanium dioxide, the processing aid, and a resin additive were kneaded with a heating roller at 130° C., thereby preparing a thermally expandable fire-resistant resin composition. The thermally expandable fire-resistant resin composition was formed into a sheet, thereby obtaining a resin layer (thickness 0.6 mm). On the resin layer, a heat resistant sheet (glass fiber paper manufactured by Oribest Co., Ltd., grammage: 30 g/m²) was stacked as the inorganic layer with a heating press set to 100° C., thereby obtaining a thermally expandable fire-resistant sheet.

The details of each component shown in Table 1 and Table 2 are as follows.

Metallocene plastomer: C6 series, MFR: 8.0 g/10 min (Sumitomo Chemical Company, Limited, product name: EXCELLEN FX402).

EVA resin: ethylene-vinyl acetate copolymer, MFR: 18 g/10 min, density: 949 kg/m³, content percentage of vinyl acetate: 28%, (TOSOH CORPORATION, product name: Ultrasen (Nipoflex) 710)

Nitrogen-containing foaming agent: Melamine (Nissan Chemical Corporation).

Phosphorus flame retardant: ammonium polyphosphate (Clariant Japan K.K., product name: AP422).

Polyhydric alcohol: pentaerythritol (KOEI CHEMICAL COMPANY, LIMITED, product name: Dipentalite).

Titanium dioxide: average particle diameter 0.24 μm (Huntsman Corporation, product name: TR92).

Processing aid: Mitsubishi Chemical Corporation, product name: METABLEN A3000

The details of the resin additive shown in Table 3 are as follows.

Acrylic polymer: Mitsubishi Chemical Corporation product name: METABLEN P-501A (weight-average molecular weight: 500,000)

Acrylic polymer: Mitsubishi Chemical Corporation product name: METABLEN P-530A (weight-average molecular weight: 3,000,000)

Straight-chain acrylic polymer: Mitsubishi Chemical Corporation product name: METABLEN P-531A (weight-average molecular weight: 4,500,000)

Straight-chain acrylic polymer: Mitsubishi Chemical Corporation product name: METABLEN P-1050 (weight-average molecular weight: 10,000,000)

PTFE system: Mitsubishi Chemical Corporation product name: METABLEN A3000 (*the same as the processing aids in Table 1 and Table 2).

### (2) Evaluation Test

### (2.1) Fire-Resistant Foaming Properties

In accordance with the standard heating curve based on JIS A1304, the thermally expandable fire-resistant sheet fixed to a calcium silicate board with a tacker was heated in a furnace, and the expansion ratio of the thermally expandable fire-resistant was measured. The expansion ratio was obtained as a ratio of the thickness of the foamable heat-insulating layer after foaming to the thickness of the resin layer before foaming.

A: Expansion ratio is greater than or equal to 10 (high expansion ratio and fire resistant)

C: Expansion ratio is greater than or equal to 1 and less than 10 (low expansion ratio and non-fire-resistant).

### (2.2) Foam Denseness

The cross section of the foamable heat-insulating layer of the thermally expandable fire-resistant sheet after the test on the fire-resistant foaming properties was observed, and the average air bubble diameter was measured.

S: Average air bubble diameter is less than 100 μm (a large area of dense portions and optimal thermal insulation properties)

A: Average air bubble diameter is greater than or equal to 100 μm and less than 1000 μm (satisfactory thermal insulation properties despite both dense portions and sparse portions formed)

C: Average air bubble diameter is greater than or equal to 1000 μm (a large area of sparse portions and poor thermal insulation properties).

### (2.3) Fluidity

The kneading torque of the thermally expandable fire-resistant resin composition was measured with LABO PLASTOMILL (manufactured by Toyo Seiki Seisaku-sho, Ltd.) and was used as an index of the fluidity. That is, the thermally expandable fire-resistant resin composition was put into LABO PLASTOMILL at 100° C. and was then kneaded at a rotation speed of 10 rpm for 5 minutes, a final torque was read, and the fluidity was evaluated based on the following three stages.

A: Less than 40 N·m (optimal fluidity, easy moldability)

B: Greater than or equal to 40 N·m and less than 50 N·m (satisfactory fluidity, moldability depending on molding conditions)

C: Greater than or equal to 50 N·m (poor fluidity, heavy load applied to a molding device, and no moldability into a sheet shape).

TABLE 1
Base Material 1

| Components | Product Name, etc. | Content (parts by mass) |
|---|---|---|
| Metallocene Plastomer | EXCELLEN FX402 | 24 |
| Nitrogen-containing | Melamine | 10 |
| Foaming Agent | | |
| Phosphorus | AP422 | 30 |
| Flame Retardant | | |
| Polyhydric Alcohol | Dipentalite | 20 |
| Titanium Dioxide | TR92 | 15 |
| Processing Aid | A3000 | 1 |

| | |
|---|---|
| Total | 100 |

TABLE 2
Base Material 2

| Components | Product Name, etc. | Content (parts by mass) |
|---|---|---|
| Metallocene Plastomer | Ultrasen 710 | 24 |
| Nitrogen-containing | Melamine | 10 |
| Foaming Agent | | |
| Phosphorus | AP422 | 30 |
| Flame Retardant | | |
| Polyhydric Alcohol | Dipentalite | 20 |
| Titanium Dioxide | TR92 | 15 |
| Processing Aid | A3000 | 1 |

| | |
|---|---|
| Total | 100 |

TABLE 3

| | | | | | Fire-resistant | | | | |
|---|---|---|---|---|---|---|---|---|---|
| | | Resin Additive | | | Foaming Properties | | Foam | | |
| | Base | | Weight-average | Content | Expansion | | Denseness | Fluidity | |
| | Material | Type | Molecular Weight | (parts by mass) | Ratio | Evaluation | Evaluation | Torque | Evaluation |
| Example 1 | 1 | Acrylic | 10,000,000 | 0.1 | 11 | A | A | 33 | A |
| Example 2 | | Polymer | | 2 | 13 | A | S | 37 | A |
| Example 3 | | | | 5 | 13 | A | S | 39 | A |
| Example 4 | | | 4,500,000 | 0.1 | 10 | A | A | 32 | A |
| Example 5 | | | | 2 | 11 | A | A | 33 | A |
| Example 6 | | | | 5 | 12 | A | A | 35 | A |
| Example 7 | 2 | | | 0.1 | 10 | A | A | 31 | A |
| Example 8 | | | | 5 | 12 | A | A | 35 | A |
| Example 9 | | | 10,000,000 | 2 | 13 | A | S | 36 | A |
| Example 10 | 1 | | 4,500,000 | 7.5 | 12 | A | A | 43 | B |
| Example 11 | | | 10,000,000 | 7.5 | 12 | A | A | 45 | B |
| Example 12 | 2 | | 4,500,000 | 7.5 | 11 | A | A | 43 | B |
| Comparative | 1 | — | — | — | 10 | A | C | 31 | A |
| Example 1 | | | | | | | | | |
| Comparative | | PTFE- | — | 2 | 10 | A | C | 35 | A |
| Example 2 | | system | | | | | | | |
| Comparative | | | — | 5 | 10 | A | C | 50 | C |
| Example 3 | | | | | | | | | |
| Comparative | | Acrylic | 500,000 | 2 | 9 | C | C | 32 | A |
| Example 4 | | Polymer | | | | | | | |
| Comparative | | | 3,000,000 | 2 | 9 | C | C | 33 | A |
| Example 5 | | | | | | | | | |
| Comparative | 2 | — | — | — | 9 | C | C | 29 | A |
| Example 6 | | | | | | | | | |

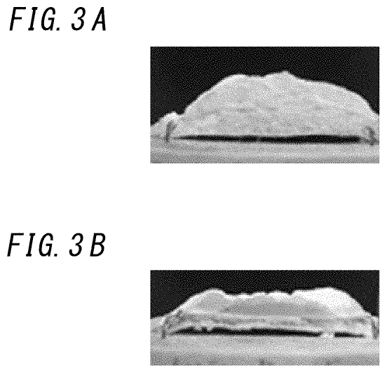

In Comparative Example 1, the fire-resistant foaming properties was at least satisfactory, but as shown in FIG. 3B, the foam denseness was low, large air bubbles were formed, and the foamable heat-insulating layer was not able to retain its shape and collapsed.

Moreover, Comparative Examples 2 and 3 each contains a PTFE-based resin additive. The fire-resistant foaming properties was as satisfactory as those in Comparative Example 1, but the foam denseness was as low as that in Comparative Example 1. That is, also in each of Comparative Examples 2 and 3, large air bubbles were formed, and then, the foamable heat-insulating layer collapsed. When the results regarding the fluidity were compared with each other between Comparative Examples 2 and 3, it was confirmed that as the content of the PTFE-based resin additive increases, the fluidity at the time of kneading decreases. From this, it is predicted that an increased size of the thermally expandable fire-resistant sheet makes the production of the thermally expandable fire-resistant sheet difficult. This is probably because viscosity required for a flow is inhibited by the PTFE-based resin additive.

Moreover, each of Comparative Examples 4 and 5 represents a case where the weight-average molecular weight of the acrylic polymer is less than 4,000,000, and in this case, the fire-resistant foaming properties slightly decreases, but no foam denseness is observed. This is probably because the weight-average molecular weight being too low results in removal of entanglement at the foaming.

Moreover, Comparative Example 6 contains no resin additive as in the case of Comparative Example 1. In Comparative Example 6, the fire-resistant foaming properties and the foam denseness were poor. One of the reasons for this is probably a difference in base material between Comparative Example 6 and Comparative Example 1.

In contrast, in Examples 1 to 12, both the fire-resistant foaming properties and the foam denseness were satisfactory (see for example, FIG. 3A showing a sectional photograph of the first example). This is probably because the molecular chain of the straight-chain acrylic polymer becoming entangled in molecules of the matrix resin suppresses the air bubbles from being enlarged at the time of foaming and from being defoamed (bursting).

The metallocene plastomer which is a matrix resin of the base material 1 is a resin having no polarity. In contrast, the EVA resin which is a matrix resin of the base material 2 is a resin having a polarity. It is presumable from the results of Examples 1 to 12 that the straight-chain acrylic polymer is able to become entangled in a matrix resin whether or not the matrix resin has a polarity. The straight-chain acrylic polymer has a polarity, and therefore, the straight-chain acrylic polymer is supposed to become entangled more likely with the EVA resin.

In particular, each of Examples 1 to 3, 9, and 11 contains a high-molecular-weight straight-chain acrylic polymer. From the results of Examples 2, 3, and 9, it was confirmed that when the content of the straight-chain acrylic polymer is within a range of greater than or equal to 2 parts by mass and less than or equal to 5 parts by mass, the foam denseness is further satisfactory.

Moreover, the results of Examples 10 to 12 show that as the content of the straight-chain acrylic polymer increases, the fluidity slightly decreases, but the reduction is negligible in comparison with Comparative Example 3.

At present, there is no straight-chain acrylic polymer having a weight-average molecular weight greater than 20,000,000. Even if there were a straight-chain acrylic polymer having a weight-average molecular weight greater than 20,000,000, the fluidity is assumed to be poor, and therefore, the content of the straight-chain acrylic polymer is limited, and the foam denseness cannot be increased as expected.

### REFERENCE SIGNS LIST

1 Thermally Expandable Fire-resistant Sheet

11 Resin Layer

1. A thermally expandable fire-resistant resin composition comprising:
a vinyl resin;
a nitrogen-containing foaming agent;
a phosphorus flame retardant;
a polyhydric alcohol;
titanium dioxide; and
a straight-chain acrylic polymer,
the straight-chain acrylic polymer having a weight-average molecular weight within a range of greater than or equal to 4,000,000 and less than or equal to 20,000,000.

2. The thermally expandable fire-resistant resin composition of claim 1, wherein
the vinyl resin includes at least one of an EVA resin or a polyolefin resin.

3. The thermally expandable fire-resistant resin composition of claim 2, wherein
the polyolefin resin contains a metallocene plastomer.

4. The thermally expandable fire-resistant resin composition of claim 1, wherein
a content of the straight-chain acrylic polymer is within a range of greater than or equal to 0.1 parts by mass and less than or equal to 8 parts by mass based on 100 parts by mass of a remaining portion of the thermally expandable fire-resistant resin composition that excludes the straight-chain acrylic polymer.

5. A thermally expandable fire-resistant sheet comprising a resin layer formed from the thermally expandable fire-resistant resin composition of claim 1.

6. The thermally expandable fire-resistant sheet of claim 5, further comprising an inorganic layer overlapping the resin layer, wherein
the inorganic layer includes glass fiber.
